(19) United States
(12) Patent Application Publication
(10) Pub. No.: US 2007/0149163 A1
(43) Pub. Date: Jun. 28, 2007

(54) Information processing apparatus

(75) Inventor: Hiroyuki Yasuta, Ome-shi (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Kabushiki Kaisha Toshiba

(21) Appl. No.: 11/641,570

(22) Filed: Dec. 18, 2006

(30) Foreign Application Priority Data
Dec. 26, 2005 (JP) 2005-373572

(51) Int. Cl. H04H 7/00; H04B 1/08

(52) U.S. Cl. 455/348; 455/3.06

(57) ABSTRACT

According to one embodiment, an information processing apparatus includes an internal receiving unit which is connected to an antenna terminal, a communicating unit which executes communication with an external receiver, a first determining unit which determines whether or not an antenna is connected to the antenna terminal, a second determining unit which determines whether or not communication between the external receiver and the communicating unit is executable, a detector which detects a route capable of receiving a broadcast data from a determination results of the first and second determining unit, a selection unit which selects one of the internal receiver and the external receiver corresponding to a detection result of the detecting unit, a reproduction unit which reproduces broadcast data, and an interrupting unit which, unless the detecting unit detects a route capable of receiving the broadcast data, interrupts supply of power to the internal receiver and the communicating unit.

### CROSS-REFERENCE TO RELATED APPLICATIONS

This application is based upon and claims the benefit of priority from Japanese Patent Application No. 2005-373572, filed Dec. 26, 2005, the entire contents of which are incorporated herein by reference.

### BACKGROUND

1. Field

The present invention relates to an information processing apparatus having a receiving unit for receiving broadcast data.

2. Description of the Related Art

Generally, a television (TV) unit includes an input change-over function for changing over a vide source to be reproduced. This input change-over function changes over a video source between a reproducing unit such as a video recorder and a TV tuner in accordance with a remote control operation by a user.

Recently, provision of the TV tuner on an information processing apparatus like a personal computer has been accelerated. To enjoy broadcast data such as currently broadcasted TV program through the personal computer, a TV antenna needs to be connected to the personal computer through an antenna cable. Thus, a place where the personal computer is used is significantly limited. Particularly, for portable computer like note-book type personal computer, its portability is seriously deteriorated.

Thus, an information processing apparatus capable of reproducing broadcast data like TV program currently broadcasted even with no antenna connected has been disclosed in Jpn. Pat. Appln. KOKAI Publication No. 2005-184645.

The information processing apparatus disclosed in the above-mentioned document supplies the receiving unit with electricity even if no path capable of receiving broadcast data is provided. Thus, there is a problem that power consumption of the apparatus increases.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing an appearance of a computer as an information processing apparatus of a first embodiment;

FIG. 2 is an exemplary perspective view of the computer of FIG. 1 as viewed from its rear side;

FIG. 3 is an exemplary diagram showing a condition in which the computer of FIG. 1 is mounted on an extension unit;

FIG. 4 is an exemplary block diagram showing an example of system structure of the computer of FIG. 1;

FIG. 5 is an exemplary diagram showing an operation table of a comparison circuit in the block diagram of FIG. 4;

FIG. 6 is an exemplary flow chart showing a procedure of broadcast data reproduction control processing to be executed by a computer;

FIG. 7 is an exemplary flow chart showing a procedure of TV reproduction control processing to be executed by a TV reproduction control program;

FIG. 8 is an exemplary block diagram showing an example of system structure of computer according to a second embodiment; and

FIG. 9 is an exemplary flow chart showing the procedure of broadcast data reproduction control processing to be executed by the computer shown in FIG. 8.

### DETAILED DESCRIPTION

Various embodiments according to the invention will be described hereinafter with reference to the accompanying drawings. In general, according to one embodiment of the invention, an information processing apparatus comprises a body, an antenna terminal provided on the body and to which an antenna is attached detachably, an internal receiving unit provided within the body and which is connected to the antenna terminal so as to receive broadcast data, a communicating unit provided within the body and which executes communication with an external receiving unit that receives the broadcast data, a first determining unit which determines whether or not the antenna is connected to the antenna terminal, a second determining unit which determines whether or not communication between the external receiving unit and the communicating unit is executable, a detecting unit which detects a route capable of receiving the broadcast data from a determination result of the first determining unit and a determination result of the second determining unit, a selection unit which selects any one of the internal receiving unit and the external receiving unit corresponding to a detection result of the detecting unit, when the detecting unit detects a route capable of receiving the broadcast data, a reproduction unit which reproduces broadcast data sent from the selected one of the internal receiving unit and the external receiving unit, and an interrupting unit which, unless the detecting unit detects a route capable of receiving the broadcast data, interrupts supply of power to the internal receiving unit and the communicating unit.

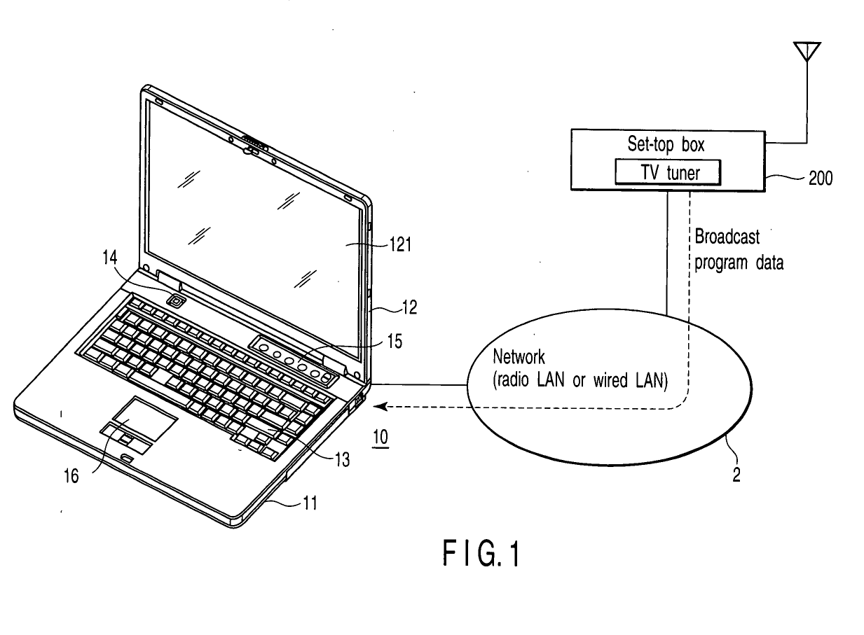

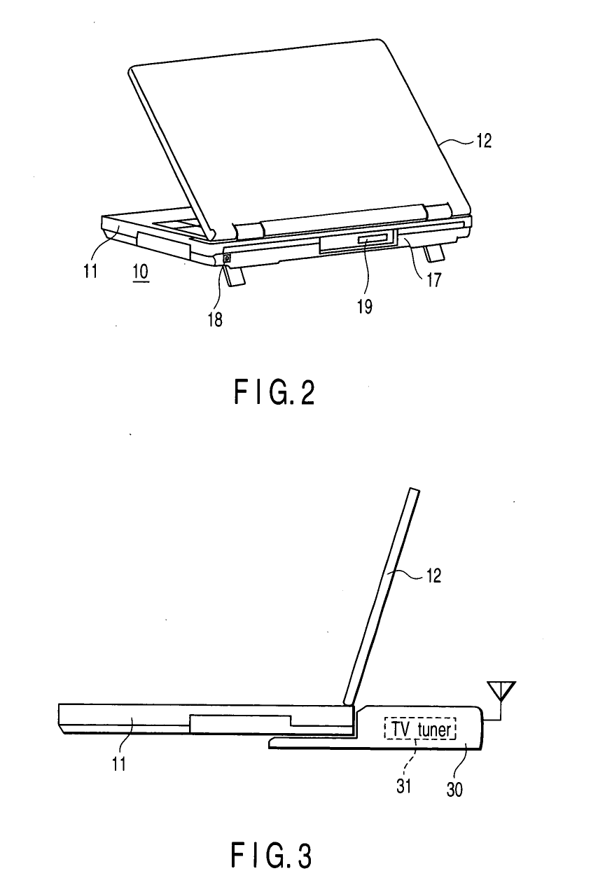

The structure of an information processing apparatus according to an embodiment of the present invention will be described with reference to FIGS. 1 and 2. This information processing apparatus is achieved as a battery drive type portable personal computer 10 like a notebook type personal computer.

FIG. 1 is a front view of a portable personal computer with its display unit opened. This computer 10 comprises a computer main body 11 and a display unit 12. A display device constituted of a liquid crystal display (LCD) 121 is incorporated in the display unit 12 and the display screen of the LCD 121 is located substantially in the center of the display unit 12.

The display unit 12 is mounted rotatably between a closed position in which the top face of the computer main body 11 is covered therewith and an open position in which the top face of the computer main body 11 is exposed. The computer main body 11 has a thin box type case, and a keyboard 13, a power button 14 for turning ON/OFF the computer 10, an input operation panel 15 including a variety of operation buttons, a touch pad 16 and the like are arranged on the top face.

The touch pad 16 is a pointing device for pointing a position on the display screen of the LCD 121. A mouse cursor (or mouse pointer) moves on the display screen corresponding to an operation of the touch pad 16.

The computer main body 11 incorporates a network controller. The network controller is a communication unit for connecting the computer 10 to a wired or wireless network 2. The computer 10 can execute communication with an external unit through the wired or wireless network 2 using the network controller. The network 2 is constituted of, for example, a wireless LAN or wired LAN.

A set top box 200 which functions as an external TV tuner is connected to the network 2. The set top box 200 is connected to a TV antenna through an antenna cable. The set top box 200 incorporates a TV tuner for receiving broadcast data such as currently broadcasted TV program. This set top box 200 has a function for distributing received broadcast data to a client through the network 2. The computer 10 is capable of receiving currently broadcasted data from the set top box 200 by executing communication with the set top box 200 through the network 2.

Further, the computer main body 11 also incorporates an internal TV tuner. The internal TV tuner receives broadcast data like the currently broadcasted TV program like the set top box 200. The computer 10 can receive the same TV program by using any of the set top box 200 and the internal TV tuner.

FIG. 2 is a rear view of the computer 10.

As shown in FIG. 2, an antenna terminal 18 to which the antenna cable can be connected detachably is provided on a rear face 17 of the computer main body 11. Further, a connector 19 for connecting the computer main body 11 to the extension unit is disposed on the rear face 17 of the computer main body 11. The extension unit is a unit which expands the function of the computer 10 and is constructed such that the computer main body 11 can be mounted detachably.

In the computer 10, any one of the internal TV tuner and external tuner (set top box 200) is automatically selected depending on whether or not a TV antenna is connected to the antenna terminal 18 through an antenna cable.

Specifically, in the computer 10, when a TV antenna is connected to the antenna terminal 18, the internal TV tuner is selected and broadcast data is reproduced from the internal TV tuner. On the other hand, if no TV antenna is connected to the antenna terminal 18, the set top box 200 is selected. In this case, communication with the set top box 200 is automatically executed so that broadcast data sent from the set top box 200 is reproduced.

In addition to the set top box 200, the extension unit can be used as an external tuner.

FIG. 3 shows a condition in which the computer main body 11 is mounted on an extension unit 30. When the computer main body 11 is mounted on the extension unit 30, the rear face of the computer main body 11 is covered by the extension unit 30 as shown in FIG. 3. Thus, although the TV antenna cannot be connected to the antenna terminal 18, the computer 10 can receive broadcast data from an external TV tuner 31 incorporated in the extension unit 30. The TV antenna is connected to the rear face of the extension unit 30 through an antenna cable. Hereinafter, it is assumed that the set top box 200 is used as the external TV tuner.

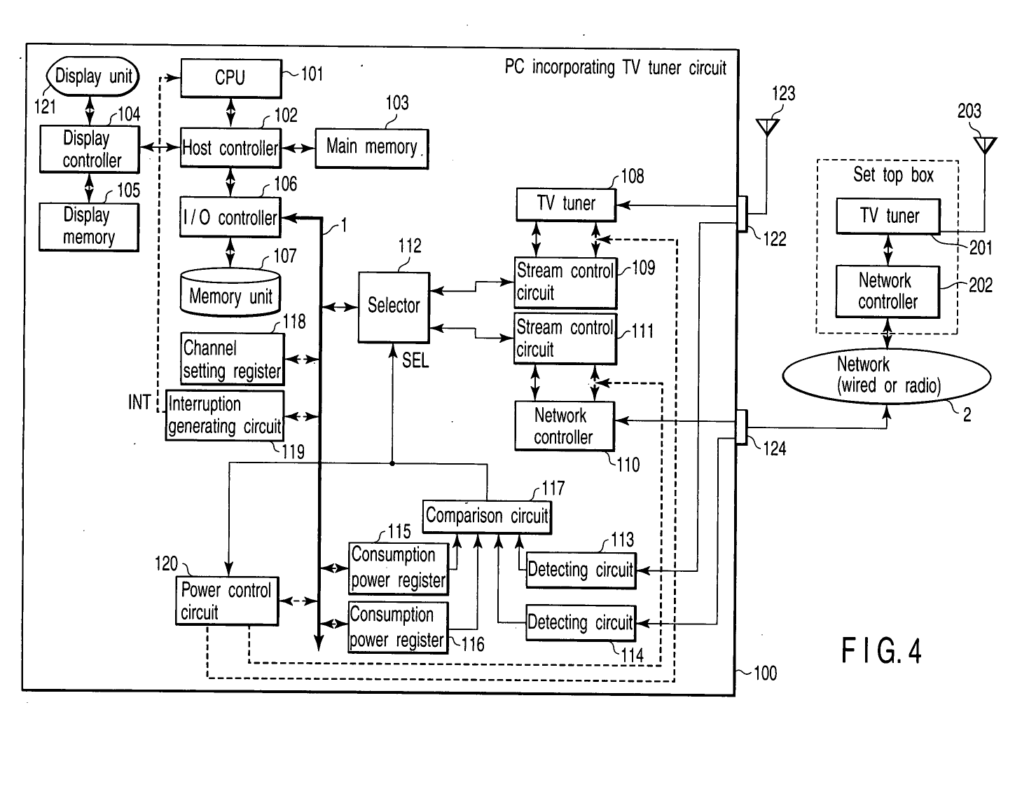

FIG. 4 shows a first example of the system structure of the computer 10.

As shown in FIG. 4, the computer 10 comprises a CPU 101, host controller 102, main memory 103, display controller 104, video memory (VRAM) 105, I/O controller 106, hard disk drive (HDD) 107, internal TV tuner 108, first stream control circuit 109, network controller 110, second stream control circuit 111, selector 112, first detection circuit 113, second detection circuit 114, first consumption power register 115, second consumption power register 116, comparison circuit 117, channel setting register 118, interruption generating circuit 119, power control circuit 120 and the like.

The CPU 101 is a processor provided to control the operation of the computer 10 and executes an operating system (OS) and a variety of application programs loaded from the hard disk drive (HDD) 107 to the main memory 103. As an application program, a TV reproduction control program is preliminarily installed in the computer 10. This TV reproduction control program is a program which reproduces broadcast data like TV program using the internal TV tuner 108 or an external TV tuner.

The host controller 102 is a bridge device for connecting between a local bus of the CPU 101 and the I/O controller 106. The host controller 102 incorporates a memory controller for access-controlling the main memory 103. The display controller 104 controls the LCD 121 used as a display monitor of the computer 10. The display controller 104 has the video memory (VRAM) 105, and displays graphics data drawn on the video memory 105 by the OS/application program on the LCD 121. Under the control of the TV reproduction control program, video data included in broadcast data received by the internal TV tuner 108 or the external TV tuner is written into the video memory 105. The display controller 104 reads out video data from the video memory 105 and displays the data on the LCD 121.

The I/O controller 106 incorporates an integrated drive electronics (IDE) controller for controlling the HDD 107. The I/O controller 106 executes control on each device on the bus 1 like a peripheral component interconnect (PCI) bus.

The internal TV tuner 108 is a device for receiving broadcast data like TV program currently broadcasted and receives broadcast data having a channel number specified by a command from the TV reproduction control program. This internal TV tuner 108 is connected to the antenna terminal 18. A TV antenna 203 can be connected to the antenna terminal 18 through an antenna cable. As the TV antenna 203, a TV antenna installed outdoor or an indoor antenna may be used.

Broadcast data of a channel number received by the internal TV tuner 108 is sent to the first stream control circuit 109. The first stream control circuit 109 converts the broadcast data received by the internal TV tuner 108 from analog signal to digital signal and generates digital YUV data (R656) type stream data from video data contained in such digitalized broadcast data. This stream data is sent to the selector 112.

The network controller 110 is a communication device which executes communication with an external device through the wired or wireless network 2. The network controller 110 is constituted of a wired network device which executes communication with an external device through the wired network or a wireless network device which executes wireless communication with an external device through the wireless network. If the network controller 110 is achieved by the wireless network device, the computer 10 can communicate with the set top box 200 no matter where a user uses the computer 10 at home. Of course, both the wired network device and wireless network device may be provided on the computer 10.

The network controller 110 receives broadcast data received by the set top box 200 through the network 2 by executing communication with the set top box 200 through the wired or wireless network 2. The broadcast data from the set top box 200 received by the network controller 110 is sent to the second stream control circuit 11. The second stream control circuit 111 generates, for example, digital YUV data (R656) type stream data from video data contained in the broadcast data from the set top box 200. This stream data is sent to the selector 112.

The selector 112 is a device which selects any one of the internal TV tuner 108 and the external TV tuner (set top box 200). The selector 112 is bi-directionally connected to the first stream control circuit 109 and also bi-directionally connected to the second stream control circuit 111. The selector 112 selects any one of the first stream control circuit 109 and the second stream control circuit 111 corresponding to a selection signal SEL from the comparison circuit 117 and connects the selected one of the first stream control circuit 109 and the second stream control circuit 111 to the bus 1.

The first detection circuit 113 is a device which determines whether or not the antenna 203 is connected to the antenna terminal 18. The first detection circuit 113 can be achieved by a mechanical switch which turns ON/OFF depending on whether or not the antenna cable is connected to the antenna terminal 18. Further, the first detection circuit 113 can be achieved by a voltage detection circuit which determines whether or not the antenna 203 is connected depending on a voltage on a signal pin of the antenna terminal 18. The first detection circuit 113 outputs “1” to the comparison circuit 117 when the antenna terminal 18 is connected to the antenna and outputs “0” when it is not connected.

The second detection circuit 114 is a circuit which determines whether or not the network controller 110 is connected to the network 2. The second detection circuit 114 determines whether or not the network controller 110 is connected to the network 2 by means of the mechanical switch 124. When the network controller 110 is connected to the network, the second detection circuit 114 outputs “1” to the comparison circuit 117 and outputs “0” if it is not connected thereto.

The first consumption power register 115 is a register for setting consumption power when the internal TV tuner 108 and the first stream control circuit 109 are actuated and is set by the CPU 101. Assume that it is set to 2000 (mW) in this embodiment.

The second consumption power register 116 is a register for setting consumption power when the network controller 110 and the second stream control circuit 111 are actuated and is set by the CPU 101. Assume that it is set to 1200 (mW) in this embodiment.

The comparison circuit 117 outputs a selection signal SEL depending on values from the first detection circuit 113, the second detection circuit 114, the first consumption power register 115 and the second consumption power register 116.

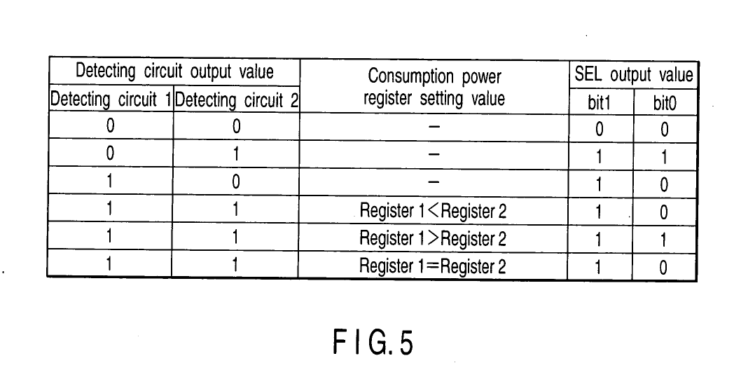

FIG. 5 is an operation table of the comparison circuit 117. In the operation table, it is assumed that an output value from the first detection circuit 113 is detection circuit 1, an output value from the second detection circuit 114 is detection circuit 2, a setting value on the first consumption power register 115 is register 1 and a setting value on the second consumption power register 116 is register 2.

The selection signal SEL is a 2-bit signal, which means that stream data from the first stream control circuit 109 is selected when bit0 is “0” and that stream data from the second stream control circuit 111 is selected when bit0 is “1”. The value of bit0 is valid only when bit1 is 1. This means that when bit1 is 0, no stream data flows to the bus 1.

Table of FIG. 5 indicates that if both output value of the first detection circuit 113 and output value of the second detection circuit 114 are 0 (detection circuit 1=0, detection circuit 2=0), there exists no route capable of receiving broadcast data. The selection signals SEL bit0, bit1 output 0 (no stream data flows to the bus 1). In this case, the values of the registers 1 and 2 are not used.

When the output value of the first detection circuit 113 is 0 and the output value of the second detection circuit 114 is 1 (detection circuit 1=0, detection circuit 2=1), it is indicated that only stream data from the second stream control circuit 111 is valid. The selection signals SEL, bit0, bit1 output 1. At this time, stream data from the second stream control circuit 111 flows to the bus 1. In this case, the values of register 1 and register 2 are not used.

When the output value of the first detection circuit 113 is 1 and the output value of the second detection circuit 114 is 0 (detection circuit 1=1, detection circuit 2=0), it is indicated that only stream data from the first stream control circuit 109 is valid. The selection signal SEL bit0 outputs “0” and bit 1 outputs “1”. At this time, the stream data from the first stream control circuit 109 flows to the bus 1. In this case, the values of the register 1 and register 2 are not used.

When the output value of the first detection circuit 113 is 1 and the output value of the second detection circuit 114 is 1 (detection circuit 1=1, detection circuit 2=1), it is indicated that both stream data from the first stream control circuit 109 and stream data from the second stream control circuit 111 are valid. The selection signal SEL is determined by a result of comparison between the register 1 and the register 2. The register 1 and resister 2 are consumption power at the time when broadcast data receiving route is used. Since, in the present invention, a receiving route having a smaller consumption power is selected, a following result occurs. Assume that according to this embodiment, when the register 1 and register 2 are of the same value, stream data from the first stream control circuit 109 is selected.

a) In Case of Register 1<Register 2

Stream data from the first stream control circuit 109 is used, selection signal SEL bit0=0, bit1=1

b) In Case of Register 1>Register 2

Stream data from the second stream control circuit 111 is used, selection signal SEL bit0=1, bit1=1

c) In Case of Register 1=Register 2

Stream data from the first stream control circuit 109 is used, selection signal SEL bit0=0, bit1=1

The channel setting register 118 is a register for recording a channel number sent to the internal TV tuner 108 or an external TV tuner 201 in the set top box 200.

The interruption generating circuit 119 is a circuit for outputting an interruption signal INT to the CPU 101 when the value of the selection signal SEL generated by the comparison circuit 117 changes. The CPU 101 can read the value of the selection signal SEL by accessing the interruption generating circuit 119 through the bus 1.

The power control circuit 120 is a circuit for controlling the power of the internal TV tuner 108, the first stream control circuit 109, the network controller 110 and the second stream control circuit 111. The powers are controlled according to a value of the selection signal SEL generated by the comparison circuit 117 and power ON command and power OFF command sent from the CPU 101.

If the power ON command is received when the stream data from the first stream control circuit 109 is selected (selection signal SEL bit0=0, bit1=1), power is supplied to the internal TV tuner 108 as an internal receiving unit and the first stream control circuit 109. When the power OFF command is received in this condition, the power control circuit 120 stops supply of power to the internal TV tuner 108 and the first stream control circuit 109. That is, supply of power to the internal TV tuner 108, the first stream control circuit 109, the network controller 110 as a communication unit and the second stream control circuit 111 is interrupted.

If the power ON command is received when the stream data from the second stream control circuit 111 is selected (selection signal SEL bit0=1, bit1=1), power is supplied to the network controller 110 as a communication unit and the second stream control circuit 111. When the power OFF command is received in this condition, the power control circuit 120 stops supply of power to the network controller 110 and the second stream control circuit 111. That is, supply of power to the internal TV tuner 108, the first stream control circuit 109, the network controller 110 as a communication unit and the second stream control circuit 111 is interrupted.

If there is no route capable of receiving broadcast data (selection signal SEL bit1=0), the power control circuit 120 interrupts supply of power to the internal TV tuner 108 as an internal receiving unit, the first stream control circuit 109, the network controller 110 as a communication unit and the second stream control circuit 111.

In the meantime, if the network controller 110 communicates with units other than the set top box 200, it is permissible to always supply power to the network controller 110 and that if no power is supplied to the communication unit, the power control circuit 120 interrupts power to the second stream control circuit 111 as a communication unit.

If neither the stream data from the first stream control circuit 109 nor the steam data from the second stream control circuit 111 is selected (selection signal SEL bit1=0), a received power ON command becomes invalid.

The set top box 200 includes the external TV tuner 201 and a network controller 202. The external TV tuner 201 is a device for receiving broadcast data such as TV program and it receives broadcast data of a channel number specified by a command sent from the computer 10 through the network 2. The external TV tuner 201 is connected to the antenna 203 through an antenna cable. Received broadcast data is sent to the network controller 202. The network controller 202 is a device for communicating with an external device through the network 2. The network controller 202 sends broadcast data received from the external TV tuner 201 to the computer 10 through the network 2.

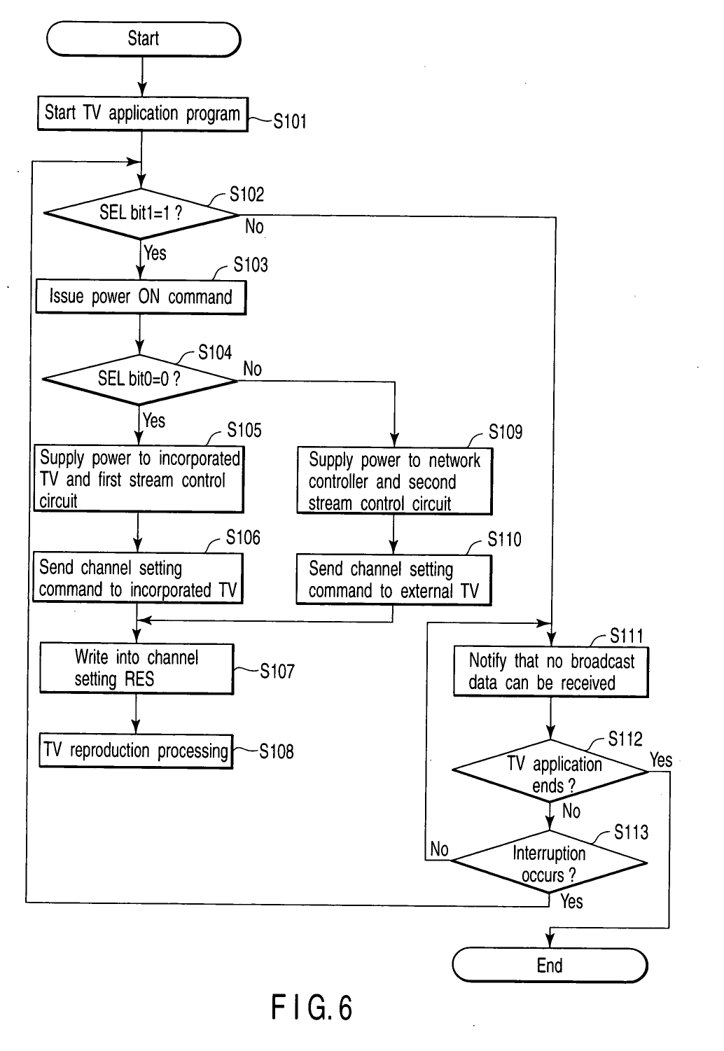

A TV reproduction control activity executed by the TV reproduction control program will be described with reference to a flow chart of FIG. 6.

When the TV reproduction control program is started (block S101), composition of the computer 10 including the CPU 101 executes the following processing under the control of the TV reproduction control program.

The CPU 101 accesses the interruption generating circuit 119 through the bus 1, reads the value of the selection signal SEL bit1 and determines whether or not the selection signal SEL bit1 is “1” (block S102). If the selection signal SEL bit1 is “1”, it is indicated that a route capable of receiving broadcast data exists.

If the value of the selection signal SEL bit1 is “1” (Yes in block S102), the CPU 101 issues a power ON command to the power control circuit 120 (block S103). The power control circuit 120 supplies power to only a device requiring it based on rule indicated on the comparison circuit operation table shown in FIG. 5.

The power control circuit 120 determines whether or not the selection signal SEL bit0 is “0” (block S104). If the selection signal SEL bit0 is “0”, it is indicated that the incorporated tuner is selected.

If the selection signal SEL bit0 is “0” (Yes in block S104), the power control circuit 120 supplies power to the internal TV tuner 108 and the first stream control circuit 109 (block S105).

After the power is supplied, the CPU 101 sends a channel setting command to the selector 112. The selector 112 determines whether or not the selection signal SEL bit0 is “0”. In this case, the selection signal SEL bit0 is “0”, and the selector 112 sends the channel setting command sent from the CPU 101 to the internal TV tuner 108 (block S108). The channel setting command is supplied to the internal TV tuner 108 via the first stream control circuit 109.

The CPU 101 stores the sent channel setting value in the channel setting register (RES) 118 (block S105).

The CPU 101 receives broadcast data supplied from the internal TV tuner 108 through the selector 112 and reproduces the data using the display controller 104 (block S106).

Broadcast data from the internal TV tuner 108 is stored in the display memory 105 through the first stream control circuit 109, the selector 112, the bus 1, the I/O controller 106, and the display controller 104. The display controller 104 converts the stream data stored in the VRAM 105 from YUV data type to RGB data type and displays the data on the LCD 121.

Note that if the power control circuit 120 has determined that the selection signal SEL bit0 is not “0” in the processing of block S104 (No in block S104), the power control circuit 120 supplies power to the network controller 110 and the second stream control circuit 111 (block S109).

Next, after the power is supplied, the CPU 101 sends a channel setting command to the selector 112. The selector 112 determines whether or not the selection signal SEL bit0 is “0”. In this case, the selection signal SEL bit0 is not “0”, and the selector 112 sends the channel setting command sent from the CPU 101 to the external TV tuner 201 (block S110). The channel setting command is supplied to the external TV tuner 201 via the second stream control circuit 111, the network controller 110, the network 2, and the network controller 202.

After the channel setting command is sent, the CPU 101 stores the sent channel setting value in the channel setting register (RES) 118 (block S105).

The CPU 101 receives broadcast data supplied from the TV tuner through the selector 112 and reproduces the data using the display controller 104 (block S106).

Broadcast data from the external TV tuner 201 is stored in the display memory 105 through the network controller 202, the network 2, the network controller 110, the second stream control circuit 111, the selector 112, the bus 1, the I/O controller 106 and the display controller 104. The display controller 104 converts the stream data stored in the VRAM 105 from YUV data type to RGB data type and displays the data on the LCD 121.

On the other hand, if the value of the selection signal SEL bit1 is 0 or there exists no route for receiving broadcast data (No in block S102) in processing of block S102, the CPU 101 writes a message saying that no broadcast data can be received into the display memory 105 and the display controller 104 displays the message written in the LCD 121 for user to be notified thereof (block S111).

If there exists no route for receiving broadcast data (No in block S102), supply of power to the internal TV tuner 108, the first stream control circuit 109, the network controller 110 as a communication unit and the second stream control circuit 111 remains interrupted.

Next, unless the TV reproduction application ends (Yes in block S112), whether or not interruption INT indicating that the value of the selection signal SEL changes is generated is determined (block S113). Unless the CPU 101 detects generation of the interruption INT, the procedure is returned to block S111, in which it continues notifying the user that no broadcast data can be received. If the CPU 101 detects generation of the interruption INT, the procedure is returned to block S102.

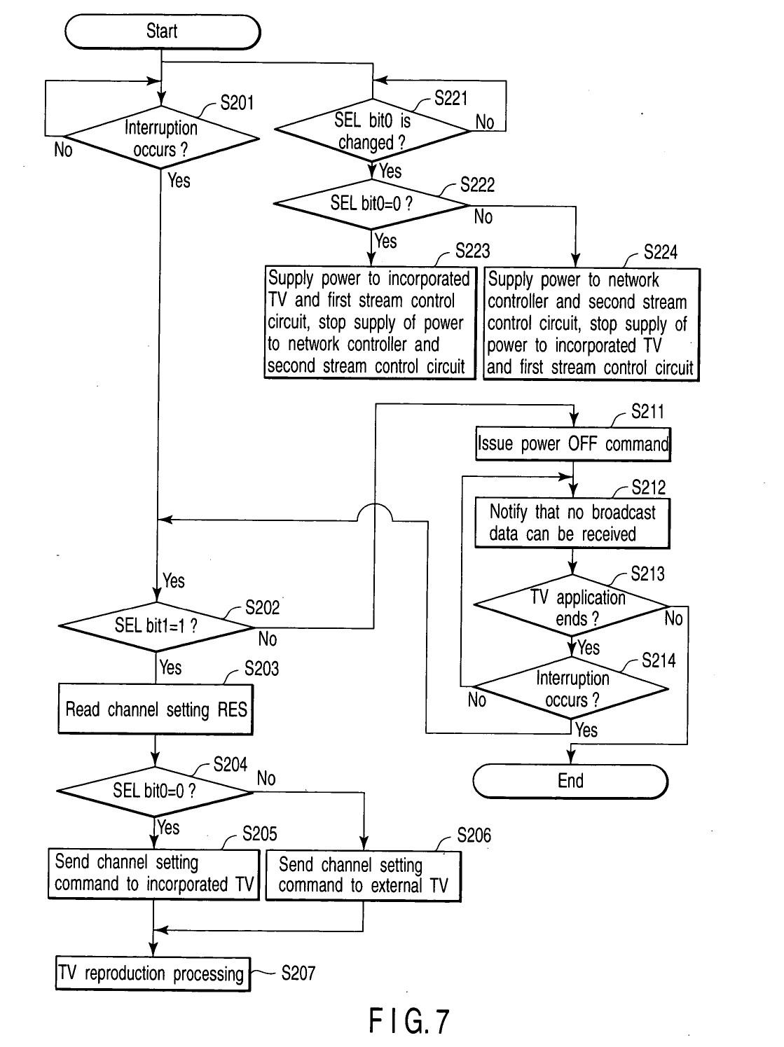

Hereinafter, the TV reproduction control activity to be executed by TV reproduction control program will be described with reference to the flow chart of FIG. 7. FIG. 7 is a flow chart of block s in which a receiving route is changed over during reproduction of broadcast data in the TV reproduction application in the computer 10.

The power control circuit 120 determines whether or not the selection signal SEL bit0 is “0” (block S222) when the selection signal SEL bit0 changes (Yes in block S221). When the selection signal SEL bit0 is “0”, it indicates that the internal TV tuner 108 is selected.

When the selection signal SEL bit0 is “0” (Yes in block S222), the power control circuit 120 supplies power to the internal TV tuner 108 and the first stream control circuit 109 and stops supply of power to the network controller 110 and the second stream control circuit 111 (block S223). When the selection signal SEL bit0 is “0” (No in block S222), the power control circuit 120 supplies power to the network controller 110 and the second stream control circuit 111 and stops supply of power to the internal TV tuner 108 and the first stream control circuit 109 (block S224). In this processing, supply of power to a unit not requiring power can be stopped and power can be supplied to a unit requiring it.

The CPU 101 executes normal processing until an interruption INT indicating that the value of the selection signal SEL changes during reproduction of broadcast data received using the TV reproduction program occurs. If the interruption INT occurs (Yes in block S201), the CPU 101 accesses the interruption generating circuit 119 through the bus 1 and reads the value of the selection signal SEL bit1 so as to determine whether or not the selection signal SEL bit1 is “1” (block S202). If the value of the selection signal SEL bit1 is “1”, it is indicated that an effective broadcast receiving route exits.

When the value of the selection signal SEL bit1 is “1” (Yes in block S202), the CPU 101 accesses the channel setting register (RES) 118 and reads a channel setting currently being reproduced (block S203). In this processing, the power ON command does not need to be issued because power is automatically controlled depending on the value of the selection signal SEL, although the power ON command is issued when a TV application is started.

Next, the CPU 101 sends the channel setting read by processing of block S203 to the selector 112. This is a processing of, if a receiving route is changed, reflecting a current channel setting to a TV tuner after the change (from the internal TV tuner to the external tuner or vice versa).

The selector 112 determines whether or not the selection signal SEL bit0 is “0” (block S204). If the selection signal SEL bit0 is “0” (Yes in block S204), the selector 112 sends a channel setting command sent from the CPU 101 to the internal TV tuner 108 (block S205). The channel setting command is supplied to the internal TV tuner 108 through the first stream control circuit 109.

If the selection signal SEL bit0 is not “0” (No in block S204), the selector 112 sends the channel setting command sent from the CPU 101 to the external TV tuner 201 (block S206). The channel setting command is sent to the external TV tuner 201 through the second stream control circuit 111, the network controller 110, the network 2 and the network controller 202.

After the processing of block S205 or the processing of block S206, the CPU 101 receives broadcast data supplied from the TV tuner via the selector 112 and reproduces the data using the display controller 104 (block S207).

On the other hand, if the selection signal SEL bit1 is 0 or no valid broadcast data receiving route exists in the processing of block S202 (No in block S202), it is indicated that no valid broadcast data receiving route exists. The CPU 101 sends a power OFF command to the power control circuit 120 (block S211). If the value of the selection signal SEL bit1 is 0, supply of power to the TV tuner is interrupted to suppress consumption of power because it is indicated that no valid broadcast data receiving route exists.

By receiving a power OFF command when selecting stream data from the first stream control circuit 109 (selection signal SEL bit0=0, bit1=1), the power control circuit 120 stops supply of power to the internal TV tuner 108 and the first stream control circuit 109. That is, supply of power to the internal TV tuner 108, the first stream control circuit 109, the network controller 110 as a communication unit and the second stream control circuit 111 is interrupted.

By receiving a power OFF command when selecting stream data from the second stream control circuit 111 (selection signal SEL bit0=0, bit1=1), the power control circuit 120 stops supply of power to the network controller 110 and the second stream control circuit 111. That is, supply of power to the internal TV tuner 108, the first stream control circuit 109, the network controller 110 as a communication unit and the second stream control circuit 111 is interrupted.

Next, the CPU 101 writes a message saying that no broadcast data can be received into the display memory 105 and the display controller 104 displays a message written in the LCD 121 for user to be notified thereof (block S212).

Next, unless the TV reproduction application ends (Yes in block S112), whether or not an interruption INT indicating that the value of the selection signal SEL changes occurs is determined (block S113). Unless the CPU 101 detects generation of the interruption INT, the procedure is returned to block S111, in which it continues notifying the user that no broadcast data can be received. If the CPU 101 detects generation of the interruption INT, the procedure is returned to block S102.

If the broadcast data route is changed or no broadcast data can be received in the above processing, the route can be automatically changed over or the power can be controlled.

### Second Embodiment

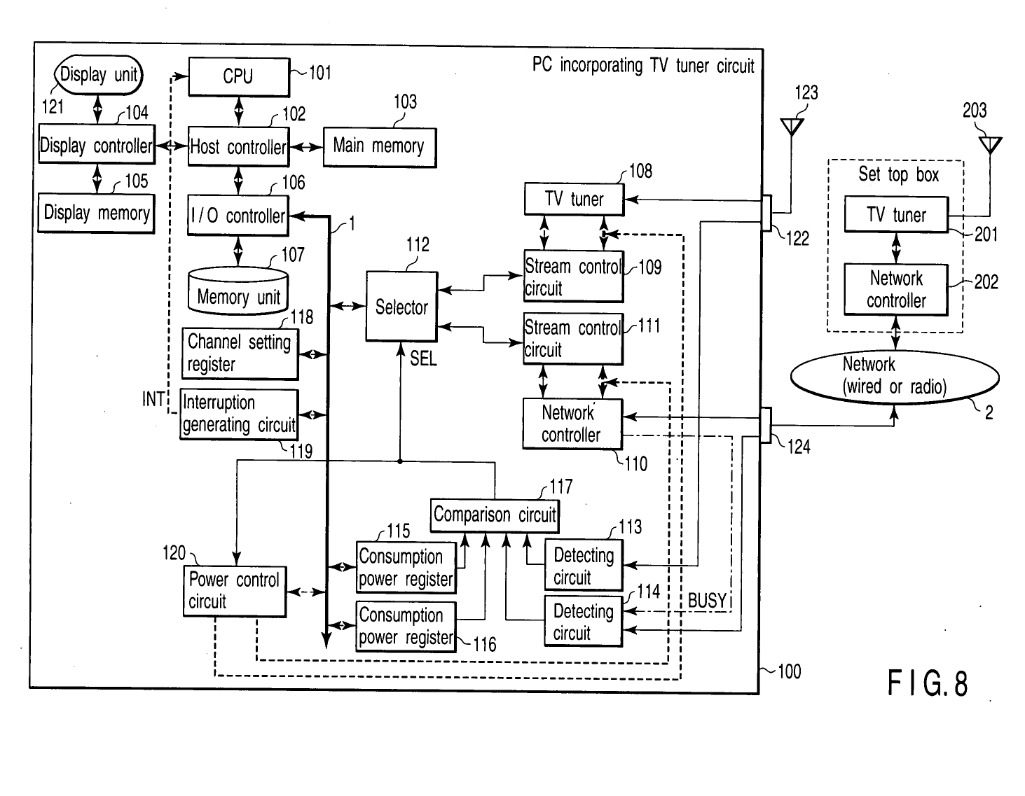

FIG. 8 is a schematic block diagram showing the system configuration of a computer according to a second embodiment.

This embodiment is different from the computer system configuration shown in FIG. 4 in that BUSY signal is outputted from the network controller 110 to the second detecting circuit 114.

The BUSY signal outputted from the network controller 110 is a signal which is controlled by sending a on-use recognition command from the CPU 110 when the external tuner (set top box 200) is selected by the ?selection signal (selector)? 112. According to this embodiment, if the set top box 200 is used by other user connected to the network 2, 1 is outputted and otherwise, 0 is outputted.

The second detecting circuit 114 controls an input signal from the mechanical switch 124 (hereinafter referred to as input signal) and a signal outputted from and the BUSY signal added in this embodiment to the comparison circuit 117. The output signals from the detecting circuit 114 (hereinafter referred to as output signal) are as follows.

a) input signal=0, BUSY signal=0→output signal=0

b) input signal=0, BUSY signal=1→output signal=0

c) input signal=1, BUSY signal=0→output signal=1

d) input signal=1, BUSY signal=1→output signal=0

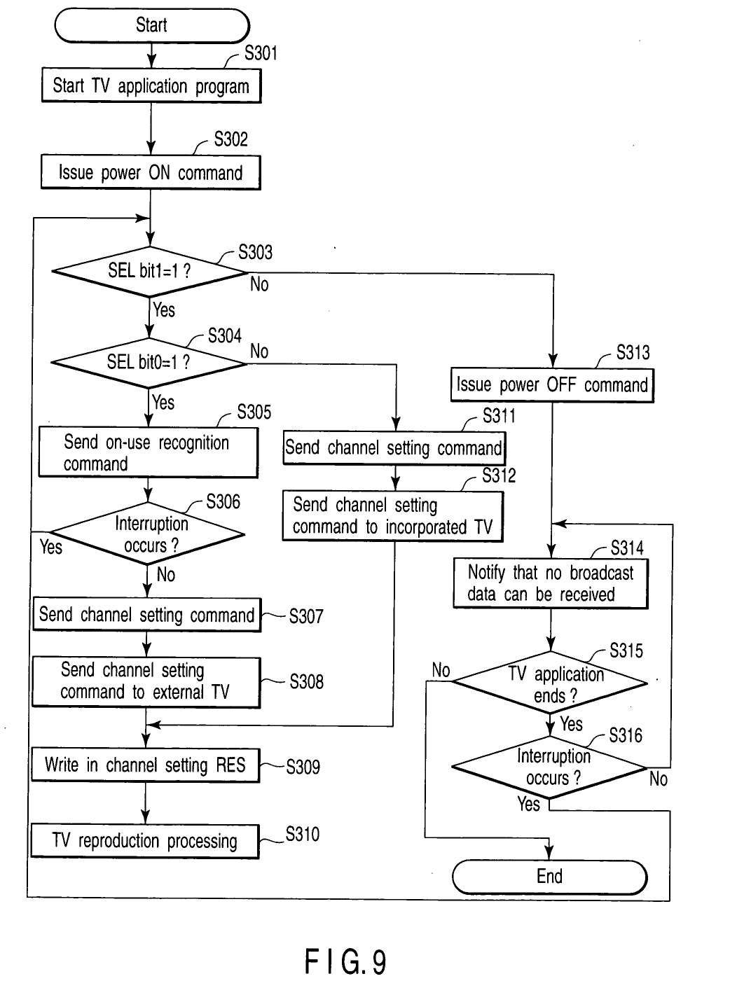

FIG. 9 is a flow chart when the TV application in the computer system configuration shown in FIG. 8 is started. This flow chart is different from the flow chart of FIG. 6 in that a processing for verifying whether or not the set top box 200 is being used by other user is added.

When the TV reproduction program is started (block 301), the CPU 101 executes following processing. The composition of the computer 10 including the CPU 101 issues a power ON command to the power control circuit 120 (block 302). The power control circuit 120 supplies power to only a device requiring it based on a rule indicated on the comparison circuit operation table shown in FIG. 5.

The CPU 101 accesses the interruption generating circuit 119 through the bus 1, reads the value of the selection signal SEL bit1 and determines whether or not the selection signal SEL bit1 is “1” (block S302). If the selection signal SEL bit1 is “1”, it is indicated that an valid broadcast data receiving route exists.

If the value of the selection signal SEL bit1 is 1 (Yes in block S302), the CPU 101 accesses the interruption generating circuit 119 through the bus 1 and reads the value of the selection signal SEL bit0 so as to determine whether or not the value of the bit0 is “1” (block 303). If the value of the selection signal SEL bit0 is 1, it is indicated that the external TV tuner is selected.

If the value of the selection signal SEL bit0 is “1” (Yes in block S304), the CPU 101 sends a on-use recognition command to the external TV tuner 201 (block 305).

The on-use recognition command is supplied to the network controller 202 through the bus 1, the selector 112, the second stream control circuit 111, the network controller 110 and the network 2. When the on-use recognition command is received, the network controller 202 notifies the network controller 110 that if the set top box 200 is being used by other user, the set top box 200 is being used by other user through the network 2. The network controller 110 controls a BUSY signal to be outputted to the second detecting circuit 114 from the received notification.

The CPU 101 determines whether or not the interruption signal INT is outputted (block S306). At a stage before the on-use recognition command is sent, as for the selection signal SEL, bit1 is “1” and bit0 is “1”. That is, other user is not using the set top box 200 and broadcast data from the set top box 200 is displayed.

If the on-use recognition command is received after the set top box 200 begins to be used by other user, the BUSY signal outputted by the network controller 202 changes from “0” to “1”. When the BUSY signal changes from “0” to “1”, the second detecting circuit 114 changes a signal to be outputted to the comparison circuit 117 from “1” to “0”. The value of the selection signal SEL which the comparison circuit 117 outputs changes depending on a change of the signal. If the interruption generating circuit 119 detects a change of the value of the selection signal SEL, the interruption signal INT is outputted to the CPU 101.

If the interruption signal INT is detected (Yes in block S306), the procedure is returned to block 303.

Unless the interruption signal INT is detected (No in block S306), the CPU 101 sends a channel setting command to the selector 112 (block 307).

The selector 112 determines whether or not the selection signal SEL bit0 is “0”. In this case, the selection signal SEL bit0 is not “0” and the selector 112 sends a channel setting command sent from the CPU 101 to the external TV tuner 201 (block S308). The channel setting command is sent to the external TV tuner 201 through the second stream control circuit 111, the network controller 110, the network 2, and the network controller 202.

After the channel setting command is set, the CPU 101 stores the sent channel setting value in the channel setting register (RES) 118 (block S309).

The CPU 101 receives broadcast data supplied from the TV tuner through the selector 112 and reproduces it using the display controller 104 (block S310).

The broadcast data from the external TV tuner 201 is stored in the display memory 105 through the network controller 202, the network 2, the network controller 110, the second stream control circuit 111, the selector 112, the bus 1, the I/O controller 106 and the display controller 104. The display controller 104 converts the stream data stored in the VRAM 105 from YUV data format to RGB data format and displays the data on the LCD 121.

Unless the value of the selection signal SEL bit0 is “1” in the processing of block S304, the CPU 101 sends a channel setting command to the selector 112 (block S311).

The selector 112 determines whether or not the selection signal SEL bit0 is “1”. In this case, the selection signal SEL bit0 is not “1”, and the selector 112 sends the channel setting command sent from the CPU 101 to the internal TV tuner 108 (block S312). The channel setting command is supplied to the internal TV tuner 108 through the first stream control circuit 109.

Next, the CPU 101 stores the sent channel setting value in the channel setting register (RES) 118 (block S309).

The CPU 101 receives the broadcast data supplied from the internal TV tuner 108 through the selector 112 and reproduces it using the display controller 104 (block S310).

The broadcast data from the internal TV tuner 108 is stored in the display memory 105 through the first stream control circuit 109, the selector 112, the bus 1, the I/O controller 106, and the display controller 104. The display controller 104 converts the stream data stored in the VRAM 105 from YUV data format to RGB data format and displays the data on the LCD 121.

On the other hand, if the value of the selection signal SEL bit1 is 0 in the processing of block S303 (No in block S303), the CPU 101 sends a power OFF command to the power control circuit 120 (block S313). If the value of the selection signal SEL bit1 is 0 (No in block S303), it is indicated that no valid broadcast data receiving route exists.

When the power OFF command is received during supply of power, the power control circuit 120 interrupts supply of power to the internal TV tuner 108, the first stream control circuit 109, the network controller 110 and the second stream control circuit 111.

The CPU 101 writes a message saying that no broadcast data can be received into the display memory 105 and the display controller 104 displays the message written in the LCD 121 for user to be notified thereof (block 314).

Unless the TV reproduction application ends (Yes in block S315), whether or not an interruption INT indicating that the value of the selection signal SEL changes occurs is determined (block S316). Unless the CPU 101 detects generation of the interruption INT (No in block S316), the procedure is returned to block S314, in which it continues notifying the user that no broadcast data can be received. If the CPU 101 detects generation of the interruption INT, the procedure is returned to block S303.

When other unit uses the set top box 200 in the above processing, the broadcast data can be obtained using the internal TV tuner if the internal TV tuner can be used.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a body;
an antenna terminal provided on the body and to which an antenna is attached detachably;
an internal receiving unit provided within the body and which is connected to the antenna terminal so as to receive broadcast data;
a communicating unit provided within the body and which executes communication with an external receiving unit that receives the broadcast data;
a first determining unit which determines whether or not the antenna is connected to the antenna terminal;
a second determining unit which determines whether or not communication between the external receiving unit and the communicating unit is executable;
a detecting unit which detects a route capable of receiving the broadcast data from a determination result of the first determining unit and a determination result of the second determining unit;
a selection unit which selects any one of the internal receiving unit and the external receiving unit corresponding to a detection result of the detecting unit, when the detecting unit detects a route capable of receiving the broadcast data;
a reproduction unit which reproduces broadcast data sent from the selected one of the internal receiving unit and the external receiving unit; and
an interrupting unit which, unless the detecting unit detects a route capable of receiving the broadcast data, interrupts supply of power to the internal receiving unit and the communicating unit.

2. The information processing apparatus according to claim 1, further comprising a supply unit which supplies power selectively to the selected one of the internal receiving unit and the communicating unit.

3. The information processing apparatus according to claim 1, further comprising:
a first storage unit which stores a value of consumption power in the internal receiving unit; and
a second storage unit which stores a value of consumption power in the communicating unit,
wherein the selection unit selects any one of the internal receiving unit and the external receiving unit corresponding to the value of consumption power stored in the first storage unit and the value of consumption power stored in the second storage unit, when the detecting unit detects a route capable of receiving the broadcast data.

4. The information processing apparatus according to claim 1, further comprising a notifying unit which, when the detecting unit detects that the route capable of receiving the broadcast data is changed, notifies the selection unit that the route capable of receiving is changed,
wherein the selection unit reselects one of the internal receiving unit and the external receiving unit corresponding to a detection result of the detecting unit, when the detecting unit detects a route capable of receiving the broadcast data after the notification from the notifying unit.

5. The information processing apparatus according to claim 1, further comprising a sending unit which sends a recognition command to the external receiving unit,
wherein the external receiving unit is capable of being shared by a plurality of apparatuses and has a notifying unit which, when the recognition command is received, notifies an apparatus which has issued the recognition command of whether or not the recognition command is used by other apparatus than the apparatus which has issued the recognition command, and
if it is determined that communication between the external receiving unit and the communicating unit is executable, the second determining unit determines that communication between the external receiving unit and the communicating unit is not executable when it is notified that an apparatus using the recognition command exists from the notifying unit.

6. The information processing apparatus according to claim 1, further comprising a notifying unit which notifies a user that the broadcast data is incapable of being received, when the detecting unit determines that no route capable of receiving the broadcast data exists.

7. The information processing apparatus according to claim 1, wherein the communication unit includes a network communication unit which executes communication with the external receiving unit through network.

8. The information processing apparatus according to claim 1, wherein the communication unit includes a radio communication unit which executes radio communication with the external receiving unit.

9. An information processing apparatus which is capable of being shared by a plurality of apparatuses and capable of reproducing broadcast data received by an external receiving unit containing
a notifying unit which notifies an apparatus which has issued the recognition command of whether or not the recognition command is used by other apparatus than the apparatus which has issued the recognition command when a recognition command is received, the information processing apparatus comprising:
a body;
an antenna terminal provided on the body and to which an antenna is attached detachably;
an internal receiving unit provided within the body and which is connected to the antenna terminal so as to receive broadcast data;
a communicating unit provided within the body and which executes communication with the external receiving unit;
a first determining unit which determines whether or not the antenna is connected to the antenna terminal;
an issuing unit which issues the recognition command;
a second determining unit which determines whether or not communication between the external receiving unit and the communicating unit is executable, and which, if it is determined that the communication between the external receiving unit and the communicating unit is executable, determines that communication between the external receiving unit and the communicating unit is not executable when it is notified that an apparatus using the recognition command exists from the notifying unit;
a detecting unit which detects a route capable of receiving the broadcast data from a determination result of the first determining unit and a determination result of the second determining unit;
a selection unit which, if the detecting unit detects a route capable of receiving the broadcast data, selects any one of the internal receiving unit and the external receiving unit corresponding to a detection result of the detecting unit; and
a reproduction unit which reproduces broadcast data sent from the selected one of the internal receiving unit and the external receiving unit.

10. The information processing apparatus according to claim 9, further comprising a notifying unit which, if the detecting unit determines that no route capable of receiving the broadcast data exists, notifies a user that the broadcast data is incapable of being received.

11. The information processing apparatus according to claim 9, wherein the communication unit includes a network communication unit which executes communication with the external receiving unit through network.

12. The information processing apparatus according to claim 9, wherein the communication unit includes a radio communication unit which executes radio communication with the external receiving unit.
